(19) United States
(12) Patent Application Publication
(10) Pub. No.: US 2024/0129430 A1
(43) Pub. Date: Apr. 18, 2024

(54) DISPLAY DEVICE AND SYSTEM

(71) Applicant: JAPAN DISPLAY INC., Tokyo (JP)

(72) Inventors: Kazunari TOMIZAWA, Tokyo (JP); Naoshi GOTO, Tokyo (JP); Tsutomu HARADA, Tokyo (JP); Junji KOBASHI, Tokyo (JP)

(21) Appl. No.: 18/380,435

(22) Filed: Oct. 16, 2023

(30) Foreign Application Priority Data
Oct. 17, 2022 (JP) 2022-166128

(51) Int. Cl. H04N 7/14; H04N 23/57; H04N 23/611; H04N 23/90

(52) U.S. Cl. CPC H04N 7/144; H04N 23/57; H04N 23/611; H04N 23/90

(57) ABSTRACT

According to one embodiment, a display device includes a display panel having a display area where an image is displayed, a plurality of cameras provided at positions overlapping with the display area in plan view to capture a user opposed to the display device as a subject, a controller selecting one of the plurality of cameras as a camera to capture the subject, based on positions of eyes of a person included in the image displayed in the display area.

### CROSS-REFERENCE TO RELATED APPLICATIONS

This application is based upon and claims the benefit of priority from Japanese Patent Application No. 2022-166128, filed Oct. 17, 2022, the entire contents of which are incorporated herein by reference.

### FIELD

Embodiments described herein relate generally to a display device and a system.

### BACKGROUND

In recent years, web conference and video call using a display device with an in-camera have become prevalent. In such web conference and video call, the line of sight of a person watching an image (video) displayed on the screen may not correspond to that of a person displayed on the screen.

For this reason, it is desired to realize a technology capable of making the line of sight of a person watching an image displayed on the screen correspond to that of a person displayed in the image.

### BRIEF DESCRIPTION OF THE DRAWINGS

FIG. 1 is a schematic perspective view showing a display device according to an embodiment.

FIG. 2 is a schematic cross-sectional view showing the display device according to the embodiment.

FIG. 3 is a plan view showing an example of a layout of sub-pixels.

FIG. 4 is a view illustrating an operation example of a display device according to a comparative example.

FIG. 5 is a block diagram showing a configuration example of the display device according to the embodiment.

FIG. 6 is a view illustrating an operation example of the display device according to the embodiment.

FIG. 7 is a view illustrating an operation example of the display device according to the embodiment.

FIG. 8 is a plan view showing an example of a layout of a camera provided in the display device according to the embodiment.

FIG. 9 is a plan view showing an example of a layout of a camera provided in the display device according to the embodiment.

FIG. 10 is a plan view showing an example of a layout of a camera provided in the display device according to the embodiment.

FIG. 11 is a view illustrating an initializing operation in the display device according to the embodiment.

FIG. 12 is a view illustrating an application example of the display device according to the embodiment.

### DETAILED DESCRIPTION

In general, according to one embodiment, a display device comprises a display panel having a display area where an image is displayed, a plurality of cameras provided at positions overlapping with the display area in plan view to capture a user opposed to the display device as a subject, a controller selecting one of the plurality of cameras as a camera to capture the subject, based on positions of eyes of a person included in the image displayed in the display area.

According to another embodiment, a display device comprises a display panel having a display area where an image is displayed, a plurality of cameras provided at positions overlapping with the display area in plan view, and a controller selecting one of the plurality of cameras as a camera to capture a subject, based on a predetermined position included in the image displayed in the display area.

According to yet another embodiment, a system includes a first display device used by a first user and a second display device used by a second user, and allows the first display device and the second display device to be communicatively connected to each other. The first display device comprises a first display panel having a first display area where an image is displayed, a plurality of first cameras provided at positions overlapping with the first display area in plan view to capture the first user, and a first controller selecting one of the plurality of first cameras as a camera to capture the first user, based on positions of eyes of the second user included in the image displayed in the first display area, and transmitting the image including the first user captured by the selected camera to the second display device. The second display device comprises a second display panel having a second display area where an image is displayed, a plurality of second cameras provided at positions overlapping with the second display area in plan view to capture the second user, and a second controller selecting one of the plurality of second cameras as a camera to capture the second user, based on positions of eyes of the first user included in the image displayed in the second display area, and transmitting the image including the second user captured by the selected camera to the first display device.

Embodiments will be described hereinafter with reference to the accompanying drawings.

The disclosure is merely an example, and the invention is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by like reference numerals and their detailed descriptions may be omitted.

FIG. 1 is a schematic perspective view showing a display device 1 according to an embodiment. In the embodiment, a first direction X, a second direction Y, and a third direction Z are defined as shown in FIG. 1. The first direction X, the second direction Y, and the third direction Z are, for example, directions orthogonal to one another but may intersect at an angle other than an orthogonal angle. The direction indicated by the arrow in the third direction Z may be referred to as an upper or upward direction and the opposite direction may be referred to as a lower or downward direction. In addition, viewing the display device DSP and its components in parallel with the third direction Z is referred to as plan view.

The display device 1 comprises a housing 2, a display panel 3, and a cover glass 4. The display device 1 is a display device comprising self-luminous display elements such as organic light emitting diodes (OLEDs) and micro-LEDs, and can be converted into, for example, a variety of different electronic devices such as smartphones, tablet terminals, monitor devices, PCs, and TVs.

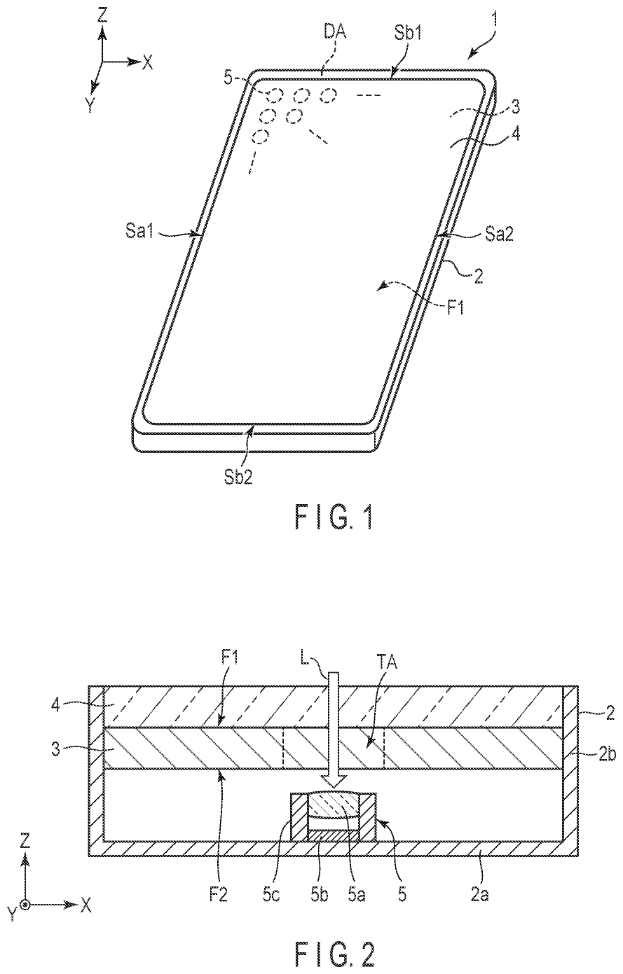

The display panel 3 is a flat panel type display panel in which a first surface F1 shown in FIG. 1 and a second surface F2 (see FIG. 2) on the side opposite to the first surface are parallel to each other, and is supported by the housing 2. The cover glass 4 covers the display panel 3. The display panel 3 has a display area DA having a large number of pixels.

In the example of FIG. 1, the display area DA has a rectangular shape having a pair of long sides Sa1 and Sa2 parallel to the second direction Y and a pair of short sides Sb1 and Sb2 parallel to the first direction X. The housing 2, the display panel 3, and the cover glass 4 also have a rectangular shape similar to the display area DA. However, the shape of the display area DA, the housing 2, the display panel 3, and the cover glass 4 is not limited to a rectangular shape, but may be the other shape such as a square, a regular circle, or an ellipse.

In the display device 1, a plurality of cameras 5 are arranged in positions overlapping with the display area DA in plan view. The cameras 5 are arranged in a space between the housing 2 and the display panel 3. The cameras 5 capture images on the first surface F1 side and may be referred to as in-cameras, front-facing cameras, or the like.

FIG. 2 is a schematic cross-sectional view showing the display device 1. The housing 2 has a bottom portion 2a and a side portion 2b which protrudes in the third direction Z from a periphery of the bottom portion 2a. The display panel 3 is supported by, for example, the side portion 2b, in a state of being separated from the bottom portion 2a.

The cover glass 4 is supported by, for example, the side portion 2b and covers the first surface F1 of the display panel 3. The cover glass 4 may be adhered to the first surface F1. The camera 5 is arranged between the second surface F2 of the display panel 3 and the bottom portion 2a of the housing 2. For example, the camera 5 is fixed to the bottom portion 2a of the housing 2.

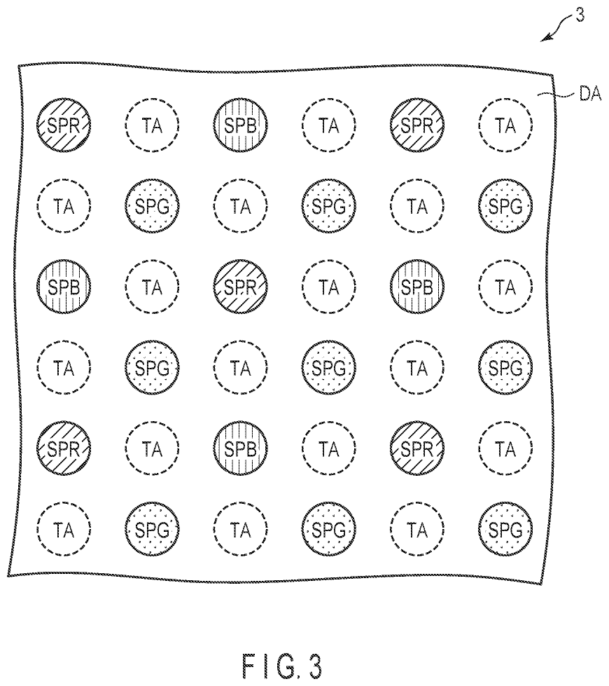

As shown in FIG. 2, the camera 5 comprises a lens unit 5a, an image sensor 5b, and a holder 5c that supports the lens unit 5a. The lens unit 5a includes one or more lenses and focuses light L passing through the transmission area TA (see FIG. 3) of the display panel 3 from the first surface F1 to the second surface F2. The image sensor 5b is, for example, a sensor including a charge coupled device (CCD) or a complementary metal oxide semiconductor (CMOS) and generates image data based on the light L focused by the lens unit 5a.

FIG. 3 is a schematic plan view showing an example of a layout of sub-pixels SP provided on the display panel 3. As shown in FIG. 3, sub-pixels SPR, SPG, and SPB and a transmission area TA are arranged in a staggered manner in the display area DA of the display panel 3. The sub-pixels SPR comprise self-luminous display elements that emit light corresponding to the red wavelength. The sub-pixels SPG comprise self-luminous display elements that emit light corresponding to the green wavelength. The sub-pixels SPB comprise self-luminous display elements that emit light corresponding to the blue wavelength. The transmission area TA is an area which transmits visible light and is an area where elements such as light-shielding wires are not arranged. The cameras 5 are arranged at positions which overlap with the transmission area TA. Incidentally, the layout and shape of the sub-pixels SPR, SPG, and SPB and the transmission area TA are not limited to those shown in FIG. 3, but various other modifications can be applied.

Incidentally, in recent years, web conference and video call using a display device with an in-camera have become prevalent. In such web conference and video call, the line of sight of a person watching an image (video) displayed on the screen may not correspond to that of a person displayed on the screen.

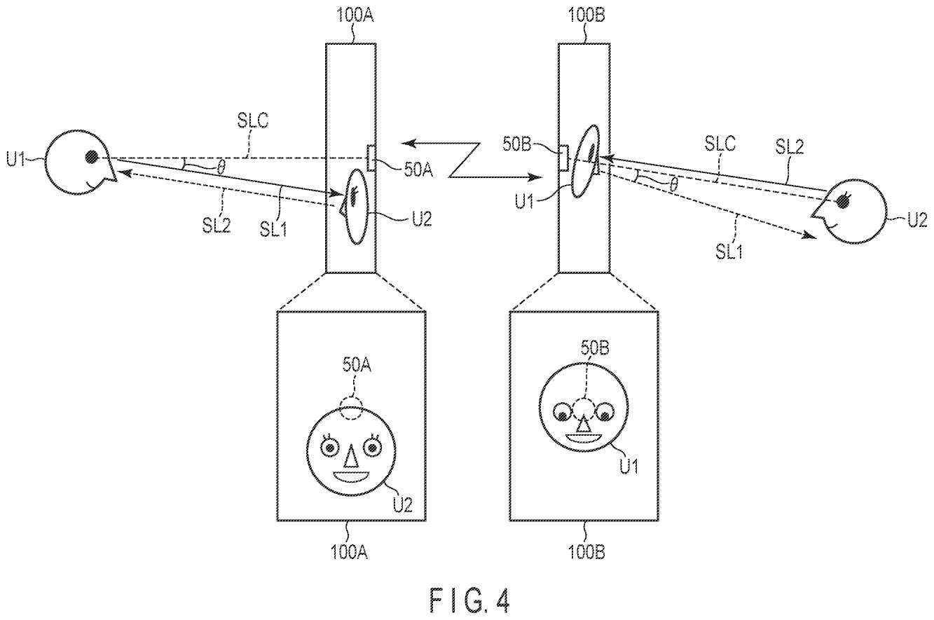

FIG. 4 is a view illustrating performing a web conference or video call using the display device 100 in which a camera (in-camera) 50 is arranged in the center of the screen.

In FIG. 4, a user U1 has a display device 100A and a user U2 has a display device 100B. An image captured by a camera 50A in the display device 100A (i.e., an image including the user U1) is transmitted to the display device 100B via a network. An image captured by a camera 50B in the display device 100B (i.e., an image including the user U2) is transmitted to the display device 100A via a network.

In FIG. 4, it is assumed that the face of the user U1 is positioned in front of the camera 50A arranged in the display device 100A and that the face of the user U2 is displaced to a lower side from the front of the camera 50B arranged in the display device 100B.

For convenience of description, it is first assumed that the user U2 who is located below the front of the camera 50B and looks at the camera, is captured by the camera 50B provided in the display device 100B. The captured image is transmitted from the display device 100B to the display device 100A via the network.

The display device 100A receives the above image transmitted from the display device 100B and displays the received image on its screen. In this case, as shown on the left side of FIG. 4, the face of the user U2 is displayed in the lower area of the screen of the display device 100A. The user U1 moves its line of sight from the front of the camera 50A to the lower area of the screen so as to watch the face of the user U2 displayed in the lower area of the screen of the display unit 100A. More specifically, as shown on the left side of FIG. 4, the user U1 moves its line of sight SL1 in a direction which forms an angle θ with the line of sight on camera SLC. According to this, the user U1 can make its line of sight match that of the user U2 displayed in the lower area of the screen of the display device 100A. In other words, the user U1 can make its line of sight SL1 correspond to a line of sight SL2 of the user U2.

On the other hand, as described above, since the line of sight SL1 of the user U1 is oriented in the direction forming the angle θ with the line of sight on camera SLC, the line of sight SL1 of the user U1 does not correspond to the line of sight on camera SLC and the camera 50A cannot capture the user U1 looking at the camera. Therefore, the camera 50A captures the face of the user U1 located in front of the camera 50A, i.e., the face of the user U1 who does not look at the camera. The captured image is transmitted from the display device 100A to the display device 100B via the network.

The display device 100B receives the above image transmitted from the display device 100A and displays the received image on its screen. In this case, as shown on the right side of FIG. 4, the face of the user U1 is displayed in the center area of the screen of the display device 100B. The user U2 moves its line of sight from the position under the front of the camera 50B to the center area of the screen so as to watch the face of the user U1 displayed in the center area of the screen of the display unit 100B. Since the camera 50B is arranged in the center of the screen of the display device 100B, the line of sight SL2 of the user U2 coincides with the line of sight on camera SLC. As described above, however, since the line of sight SL1 of the user U1 is oriented in the direction forming the angle θ with the line of sight on camera SLC, the line of sight SL1 of the user U1 does not correspond to the line of sight SL2 of the user U2 (line of sight on camera SLC). In other words, the user U2 cannot make its line of sight correspond to that of the user U1.

As described above, when web conference or video call is performed using the display device 100 comprising one camera 50 arranged in the center of the screen, if the face of one user (user U2) is displaced from the front of the camera, the other user (user U1) stops looking at the camera to make the line of sight correspond to one user (or since the camera does not catch the user's line of sight) and, as a result, one user becomes unable to make the line of sight correspond to the other user.

Therefore, the display device 1 of the embodiment proposes a configuration that can solve such a problem. More specifically, the display device 1 according to the embodiment comprises a plurality of cameras 5 and has a configuration of switching (selecting) the camera to be used for capturing according to a position of a communication partner displayed on the screen.

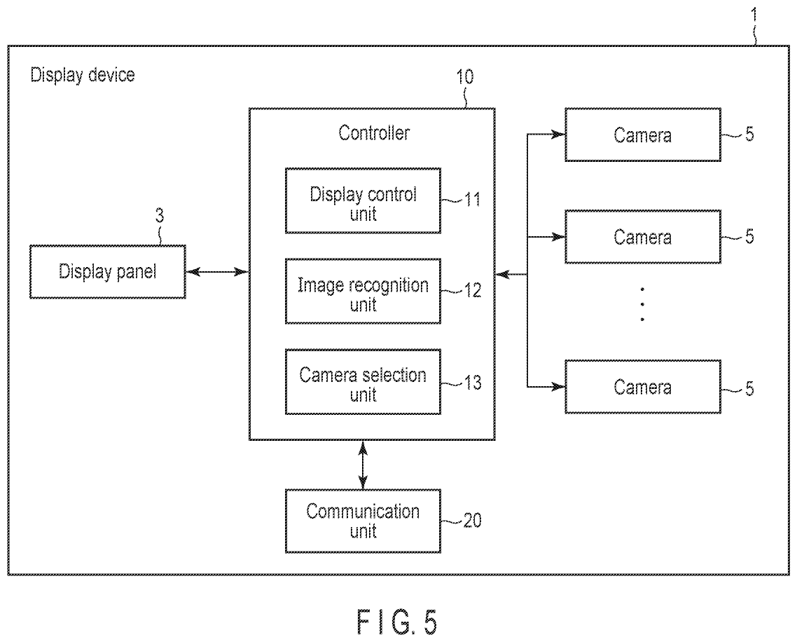

FIG. 5 is a block diagram showing a configuration example of the display device 1 according to the embodiment. As shown in FIG. 5, the display device 1 comprises a display panel 3, a plurality of cameras 5, a controller 10 (control unit), and a communication unit 20. Since the display panel 3 and cameras 5 have already been described, their detailed description is omitted here.

The controller 10 is a processor which controls the operation of each unit in the display device 1. The controller 10 includes a display control unit 11, an image recognition unit 12, and a camera selection unit 13.

The display control unit 11 controls the display of various images such as images received from an external device (for example, the display device 1 held by the communication partner in web conference or video call) on the display panel 3 via the communication unit 20. The image recognition unit 12 performs an image recognition process for an image displayed on the display panel 3 to specify predetermined positions, for example, positions of a face of a person in included in the image, and the right and left eyes of the person on the display panel 3. The camera selection unit 13 selects the camera 5 closest to the predetermined position, for example, the camera 5 located between the right and left eyes specified by the image recognition unit 12, more specifically, the camera 5 closest to the midpoint of a straight line connecting the right and left eyes, as a camera to capture the subject.

The communication unit 20 is a communication interface for performing wireless communication with an external device (for example, the display device 1 held by the communication partner in web conference or video call) via a network. The image captured by the camera 5 during the web conference or video call is transmitted to the display device 1 held by the communication partner, via the communication unit 20.

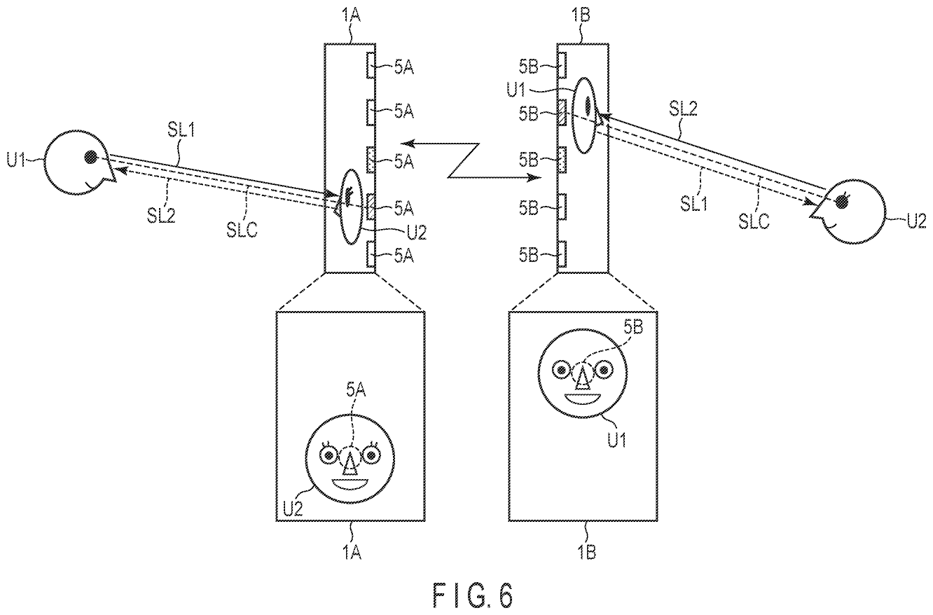

Next, the operation of the display device 1 in a case where web conference or video call is performed using the display device 1 of the embodiment will be described with reference to FIG. 6.

In FIG. 6, the user U1 holds a display device 1A and the user U2 holds a display device 1B. Images captured by cameras 5A in the display device 1A (i.e., images including the user U1 facing the display device 1A) are transmitted to the display device 1B via the network. Images captured by cameras 5B in the display device 1B (i.e., images including the user U2 facing the display device 1B) are transmitted to the display device 1A via the network.

In FIG. 6, it is assumed that the face of the user U1 is positioned in front of the camera 5A arranged in the center of the screen of the display device 1A (i.e., the camera 5A with dots in FIG. 6) and that the face of the user U2 is displaced to a lower side from the front of the camera 5B arranged in the center of the screen of the display device 1B (i.e., the camera 5B with dots in FIG. 6).

For convenience of description, it is first assumed that the user U2 who is located below the front of the camera 5B and looks at the camera, is captured by one of a plurality of cameras 5B provided in the display unit 1B. The captured image is transmitted from the display device 1B to the display device 1A via the network.

The display device 1A receives the above image transmitted from the display device 1B and displays the received image on its screen. In this case, as shown on the left side of FIG. 6, the face of the user U2 is displayed in the lower area of the screen of the display device 1A. The display device 1A performs the image recognition process of the image displayed on the screen and specifies the positions on the screen, of the right and left eyes of the user U2 displayed on the screen. Then, the display device 1A selects the camera 5A which is located between the right and left eyes of the user U2 displayed on the screen, as the camera for capturing the user U1. The camera 5A selected as the camera for capturing the user U1 (i.e., the camera 5A with hatch lines in FIG. 6), of the plurality of cameras 5A provided in the display device 1A, is hereinafter referred to as “selected camera 5A”.

The user U1 moves its line of sight to the lower area of the screen so as to watch the face of the user U2 displayed in the lower area of the screen of the display unit 1A from the front of the camera 5A arranged in the center of the screen, and can thereby make its line of sight correspond to the user U2 looking at the camera. In other words, the user U1 can make the own line of sight SL1 correspond to the line of sight SL2 of the user U2 by looking at the lower area of the screen of the display device 1A.

The display device 1A captures a situation of the user U1 at this time with the selected camera 5A. According to this, unlike the case described with reference to FIG. 4, the selected camera 5A in the display device 1A can capture the user U1 who is located on the upper side from the front of the selected camera 5A and looks at the camera. In other words, the selected camera 5A can capture the user U1 in a state where the line of sight SL1 of the user U1 coincides with the line of sight on camera SLC. The captured image is transmitted from the display device 1A to the display device 1B via the network.

The display device 1B receives the above image transmitted from the display device 1A and displays the received image on its screen. In this case, as shown on the right side of FIG. 6, the face of the user U1 is displayed in the upper area of the screen of display device 1B. The display device 1B performs the image recognition process of the image displayed on the screen and specifies the positions on the screen, of the right and left eyes of the user U1 displayed on the screen. Then, the display device 1B selects the camera 5B which is located between the right and left eyes of the user U1 displayed on the screen, as the camera for capturing the user U2. The camera 5B selected as the camera for capturing the user U2 (i.e., the camera 5B with hatch lines in FIG. 6), of the plurality of cameras 5B provided in the display device 1B, is hereinafter referred to as “selected camera 5B”.

As described above, according to the selected camera 5A of the display device 1A, since the user U1 looking at the camera is captured, the user U2 can make its line of sight correspond to the user U1 looking at the camera, by moving its line of sight to the upper area of the screen so as to watch the face of the user U1 displayed in the upper area of the screen of the display device 1B. In other words, the user U2 can make the own line of sight SL2 correspond to the line of sight SL1 of the user U1 by looking at the upper area of the screen.

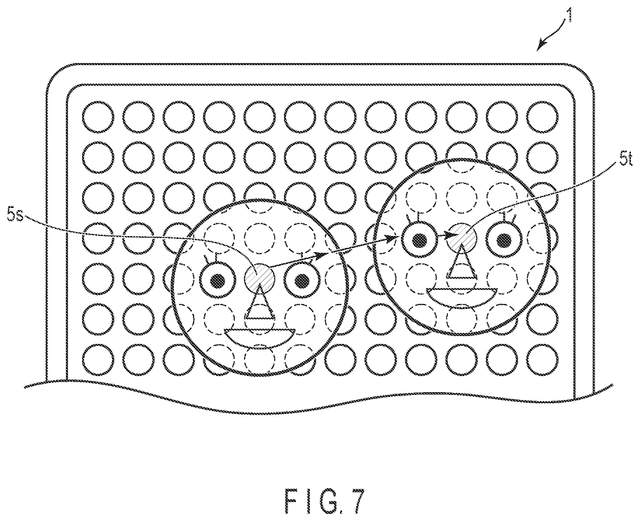

Even if the position of the communication partner's face is displaced during the series of operations shown in FIG. 6, the display device 1 of the embodiment follows and selects the camera 5 which is located between the right and left eyes on the face. For example, as shown in FIG. 7, when the position of the communication partner's face is displaced from the left side to the right side, the display device 1 cancels selecting a camera 5s which is located between the right and left eyes of the face on the left side in the figure (i.e., the face to be displaced) and which is currently selected as the camera to capture the subject, and newly selects a camera 5t which is located between the right and left eyes of the face on the right side of the figure (i.e., the displaced face) as the camera to capture the subject.

As described above, since the display device 1 of the embodiment selects the camera 5 provided at the position to which the user's line of sight is moved (more specifically, the camera 5 located between the right and left eyes of the person displayed on the screen) as the camera to capture the user, the user looking at the camera can be captured at any time. For this reason, when web conference or video call is performed using the display device 1 of the embodiment, even if the position of the face of one user (user U2) is displaced and the other user (user U1) moves its line of sight to make its line of side correspond to that of one user during the web conference or video call, the display device 1 can capture the other user looking at the camera. According to this, it is possible to make the line of sight of one user correspond to that of the other user at any time.

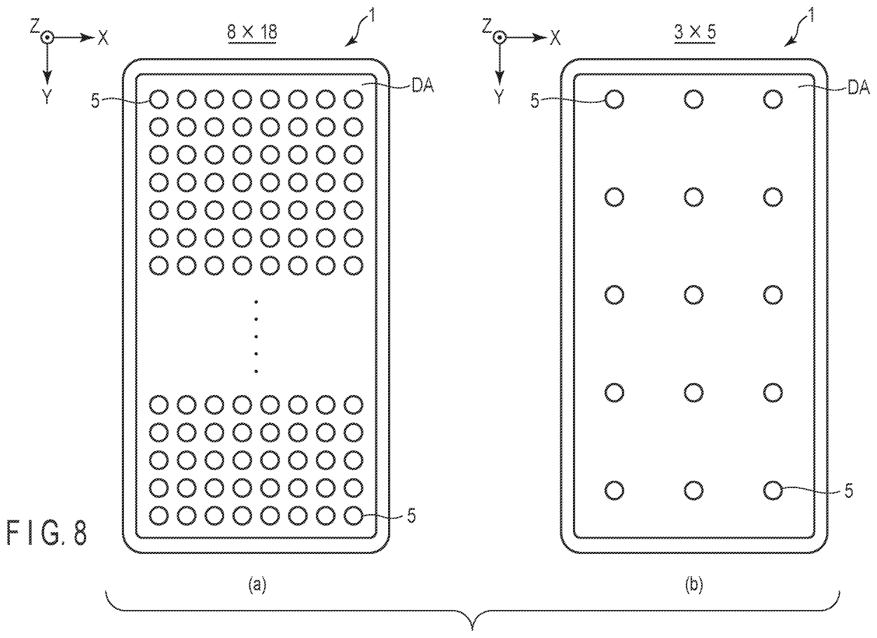

When the display device 1 of the embodiment is, for example, a 7-inch smartphone, 8×18 cameras 5 may be provided to be laid over the entire positions overlapping with the display area DA, as shown in FIG. 8(a), or 3×5 cameras 5 may be provided to be spaced apart as shown in FIG. 8(b), in the display device 1. Incidentally, in the configuration shown in FIG. 8(b), an interval between two cameras 5 adjacent in the first direction X may be the same as or different from an interval between two cameras 5 adjacent in the second direction Y. The configuration shown in FIG. 8(a), which is provided with a large number of cameras 5, is manufactured at higher costs than the configuration shown in FIG. 8(b). However, even if the communication partner's face is displayed at any position on the screen, the camera 5 located between the right and left eyes of the face displayed on the screen can be selected such that the lines of sight can be made to coincide at a high accuracy. In contrast, since the configuration shown in FIG. 8(b) reduces more number of cameras 5 than the configuration shown in FIG. 8(a), the accuracy of making the lines of sight coincide is somewhat reduced, but the lines of sight can be made to coincide at a lower cost.

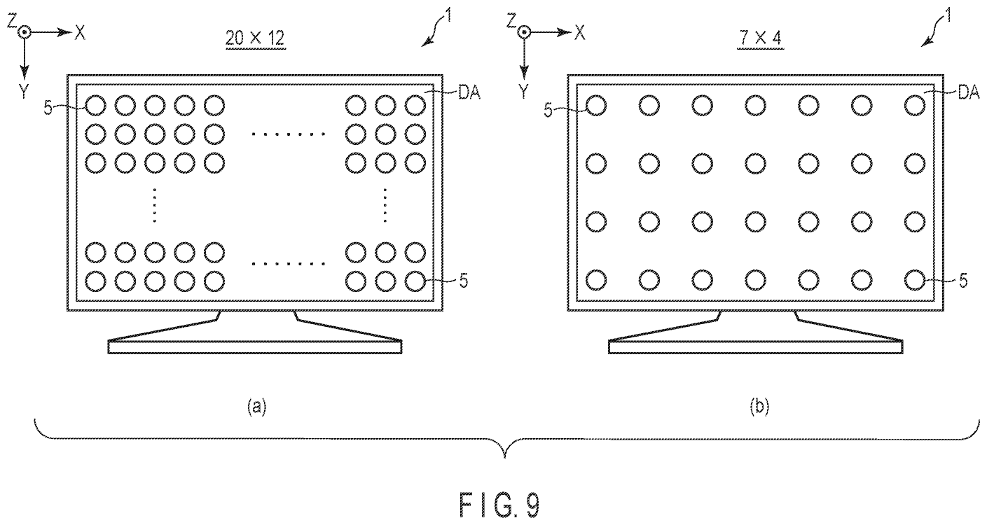

In addition, when the display device 1 of the embodiment is, for example, a 13-inch monitor device, 20×12 cameras 5 may be provided to be laid over the entire positions overlapping with the display area DA, as shown in FIG. 9(a), or 7×4 cameras 5 may be provided to be spaced apart as shown in FIG. 9(b), in the display device 1. Incidentally, in the configuration shown in FIG. 9(b), an interval between two cameras 5 adjacent in the first direction X may be the same as or different from an interval between two cameras 5 adjacent in the second direction Y. The configuration shown in FIG. 9(a), which is provided with a large number of cameras 5, is manufactured at higher costs than the configuration shown in FIG. 9(b). However, even if the communication partner's face is displayed at any position on the screen, the camera 5 located between the right and left eyes of the face displayed on the screen can be selected such that the lines of sight can be made to coincide at a high accuracy. In contrast, since the configuration shown in FIG. 9(b) reduces more number of cameras 5 than the configuration shown in FIG. 9(a), the accuracy of making the lines of sight coincide is somewhat reduced, but the lines of sight can be made to coincide at a lower cost.

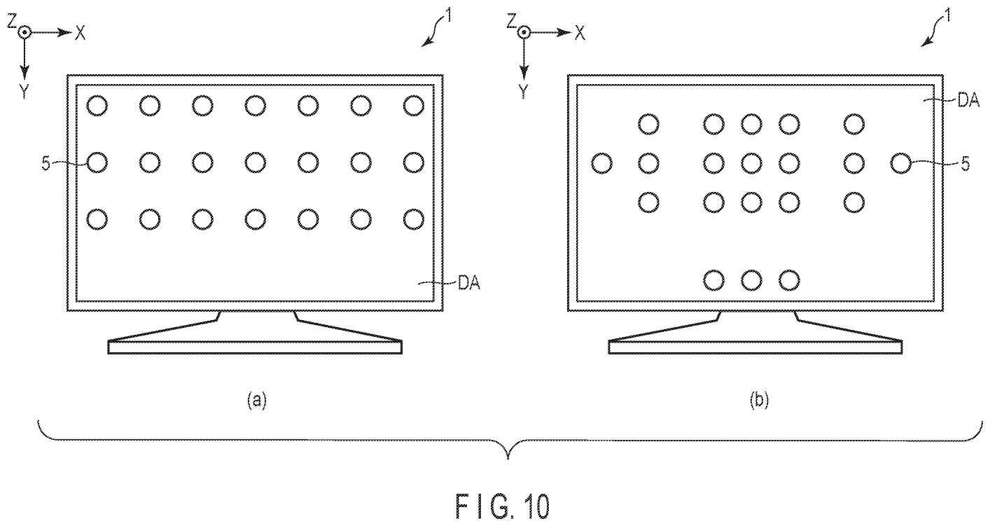

Furthermore, as shown in FIG. 10(a), the display device 1 of the embodiment may have a configuration in which the cameras 5 are not arranged in the lower area of the display area DA. Alternatively, as shown in FIG. 10(b), the display device 1 of the embodiment may have a configuration in which the cameras 5 are arranged more densely toward the central area of the display area DA. When web conference or video call is performed using the display device 1 of the embodiment, the users are expected to adjust their own positions and the position of the display device 1 such that their own faces are positioned in front of the central area of the screen. For this reason, according to the configurations shown in FIG. 10(a) and FIG. 10(b), since a large number of cameras 5 can be arranged in the area where the user's face is likely to be displayed but the number of cameras 5 arranged in the other areas can be reduced (i.e., the cameras 5 can be arranged closely together in the area where the user's face is likely to be displayed but the cameras 5 can be arranged sparsely in the area where the user's face is unlikely to be displayed), both highly accurate correspondence of the lines of sight and a low cost can be achieved. Incidentally, FIG. 10 shows a case where the display device 1 is a monitor device, but the same configuration can also be applied to a case where the display device 1 is a smartphone.

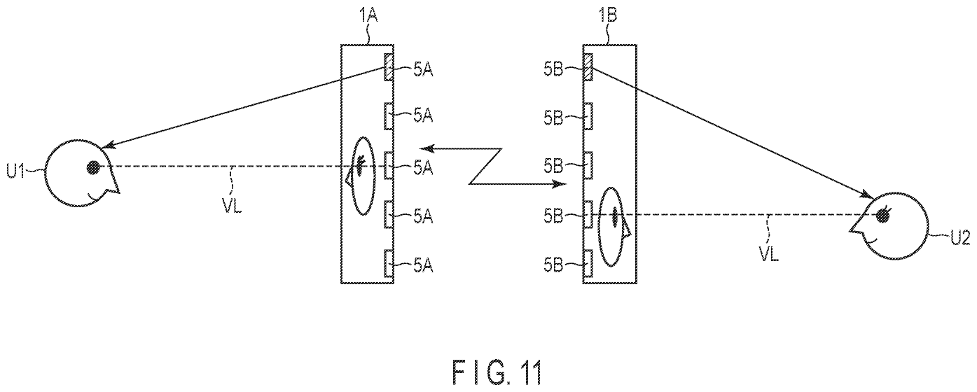

Incidentally, the display device 1 of the embodiment may perform an initializing operation to be described below before the series of operations shown in FIG. 6. FIG. 11 is a view illustrating an initializing operation performed in the display device 1 according to the embodiment.

The display device 1A performs so-called face tracking using one of a plurality of cameras 5A provided in the display device 1A to specify the position of the face of the user U1 which is the subject, and the positions of the right and left eyes of the user U1. The display device 1A generates a virtual line VL extending perpendicularly from a midpoint of a straight line connecting right and left eyes of a specified user U1 toward the display device 1A (display panel 3), and selects the camera 5A arranged at a position intersecting with the virtual line VL as a first camera 5A to capture the user U1.

In addition, when receiving an image transmitted from the display device 1B, the display device 1A adjusts the display position of the image such that the above-described first camera 5A is positioned between the right and left eyes of the user U2 included in the image. In other words, the display device 1A adjusts the display position of the image including the user U2 such that the face of the user U2 is displayed in front of the user U1.

By performing the initializing operation described above, the display device 1A can start web conference or video call in a state of displaying the face of the user U2 in front of the user U1 and selecting the camera 5A located in front of the user U1 as the camera to capture the user U1. After the initializing operation is completed, the display device 1A is set to perform the series of operations shown in FIG. 6. The initializing operation may be completed manually, for example, by the user U1 tapping a completion button displayed on the screen or may be completed automatically by detecting that the initial camera selection and the adjustment of the image display position are completed.

Incidentally, the display device LA side has been described as an example, but the same initializing operation is also performed on the display device 1B side. In addition, for face tracking in the initializing operation, the cameras 5 arranged in the upper area above the center of the screen (for example, the cameras 5A and 5B with hatch lines in FIG. 11) are desirably used to facilitate specifying the position of the subject's face and the positions of the subject's right and left eyes. Incidentally, the camera for face tracking may be prepared separately from the display device 1.

It has been described that the display device 1 is used for web conference or video call and the lines of sight of the plurality of users using the display device 1 are made to correspond to one another in the above-described embodiment, but the display device 1 according to the embodiment can also be applied to a case of capturing the own figure using an in-camera.

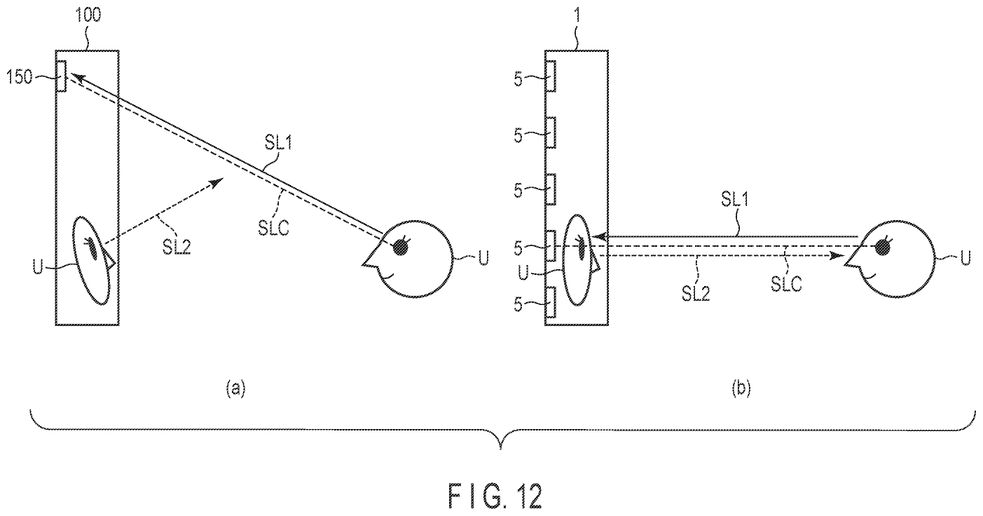

For example, as shown in FIG. 12(a), when the user U captures the own figure using a display device 200 comprising a camera (in-camera) 150 arranged at an upper part of the screen, the user U needs to move the line of sight to the camera 150 arranged at the upper part of the screen in order to capture an image in the line of sight on camera (i.e., needs to make the own line of sight SL1 correspond to the line of sight on camera SLC). In this case, however, the user U cannot see the own face displayed on the screen of the display unit 200 and cannot make the line of sight SL1 (i.e., the line of sight on camera SLC) of the user U correspond to the own line of sight SL2. In other words, the user U cannot make the own figure displayed on the screen correspond to the line of sight.

In contrast, when the user U captures the own figure using the display device 1 of the embodiment, as shown in FIG. 12(b), the camera 5 located between right and left eyes of the own figure displayed on the screen is selected as the camera to be used to capture the own figure and the user U can therefore make the own line of sight SL1, the line of sight SL2 of the own figure on the screen, and the line of sight on camera SLC. In other words, according to the display device 1 of the embodiment, the user U can capture the own figure after making the own figure displayed on the screen correspond to the line of sight.

The display device 1 according to the embodiment described above comprises a display panel 3 having a display area DA where images are displayed, a plurality of cameras 5 provided at positions overlapping with the display area DA in plan view and capturing a user of the display device 1 as a subject, and a controller 10 selecting one of the plurality of cameras 5 as a camera to capture the subject, based on positions of eyes of the person included in the image displayed in the display area DA. According to this, the line of sight of the person looking at the image displayed on the screen can be made to correspond to that of the person displayed in the image.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display panel having a display area where an image is displayed;
a plurality of cameras provided at positions overlapping with the display area in plan view to capture a user opposed to the display device as a subject; and
a controller selecting one of the plurality of cameras as a camera to capture the subject, based on positions of eyes of a person included in the image displayed in the display area.

2. The display device of claim 1, wherein
the controller selects a camera located between right and left eyes of the person included in the image displayed in the display area, of the plurality of cameras, as the camera to capture the subject.

3. The display device of claim 2, wherein
the controller selects a camera closest to a midpoint of a straight line connecting the right and left eyes of the person included in the image displayed in the display area, of the plurality of cameras, as the camera to capture the subject.

4. The display device of claim 1, further comprising:
a communication unit communicating with an external device, wherein
the controller:
selects one of the plurality of cameras as the camera to capture the subject, based on positions of eyes of a user of the external device included in the image transmitted from the external device; and
transmits the image including the subject and captured by one of the plurality of cameras, to the external device.

5. The display device of claim 1, wherein
the controller:
specifies a position of a face of the subject, using one of the plurality of cameras; and
selects a camera provided at a position intersecting with a virtual line extending perpendicularly from a position between right and left eyes of a face of the specified subject to the display panel, as a camera to capture the subject.

6. The display device of claim 5, further comprising:
a communication unit communicating with an external device, wherein
the controller transmits an image including the subject and captured by the camera provided at the position intersecting with the virtual line, to the external device.

7. The display device of claim 1, wherein
the plurality of cameras are arranged at regular intervals.

8. The display device of claim 1, wherein
the plurality of cameras include a plurality of first cameras arranged at a first density and a plurality of second cameras arranged at a second density lower than the first density.

9. The display device of claim 8, wherein
the plurality of first cameras are opposed to a central area of the display area, and
the plurality of second cameras are opposed to a surrounding area which surrounds the central area of the display area.

10. The display device of claim 1, wherein
the display area includes a first area and a second area divided in a first direction, and
the plurality of cameras are opposed to the first area and are not opposed to the second area.

11. The display device of claim 1, wherein
the display panel is a display panel including self-luminous display elements.

12. The display device of claim 1, wherein
the display panel includes a plurality of sub-pixels, and
the sub-pixels and the plurality of cameras are alternately arranged in plan view.

13. The display device of claim 1, wherein
the display panel includes a plurality of sub-pixels,
the plurality of sub-pixels includes a first sub-pixel and a second sub-pixel adjacent to the first sub-pixel, and
one of the plurality of cameras is located between the first sub-pixel and the second sub-pixel in plan view.

14. A display device comprising:
a display panel having a display area where an image is displayed;
a plurality of cameras provided at positions overlapping with the display area in plan view; and
a controller selecting one of the plurality of cameras as a camera to capture a subject, based on a predetermined position included in the image displayed in the display area.

15. The display device of claim 14, wherein
the plurality of cameras are arranged at regular intervals.

16. The display device of claim 14, wherein
the plurality of cameras include a plurality of first cameras arranged at a first density and a plurality of second cameras arranged at a second density lower than the first density.

17. The display device of claim 16, wherein
the plurality of first cameras are opposed to a central area of the display area, and
the plurality of second cameras are opposed to a surrounding area which surrounds the central area of the display area.

18. The display device of claim 14, wherein
the display area includes a first area and a second area divided in a first direction, and
the plurality of cameras are opposed to the first area and are not opposed to the second area.

19. The display device of claim 14, wherein
the display panel includes a plurality of sub-pixels,
the plurality of sub-pixels includes a first sub-pixel and a second sub-pixel adjacent to the first sub-pixel, and
one of the plurality of cameras is located between the first sub-pixel and the second sub-pixel in plan view.

20. A system including a first display device used by a first user and a second display device used by a second user, and allowing the first display device and the second display device to be communicatively connected to each other, wherein
the first display device comprises:
a first display panel having a first display area where an image is displayed;
a plurality of first cameras provided at positions overlapping with the first display area in plan view to capture the first user; and
a first controller selecting one of the plurality of first cameras as a camera to capture the first user, based on positions of eyes of the second user included in the image displayed in the first display area, and transmitting the image including the first user captured by the selected camera to the second display device, and
the second display device comprises:
a second display panel having a second display area where an image is displayed;
a plurality of second cameras provided at positions overlapping with the second display area in plan view to capture the second user; and
a second controller selecting one of the plurality of second cameras as a camera to capture the second user, based on positions of eyes of the first user included in the image displayed in the second display area, and transmitting the image including the second user captured by the selected camera to the first display device.
